(19) United States
(12) Patent Application Publication
(10) Pub. No.: US 2025/0283592 A1
(43) Pub. Date: Sep. 11, 2025

(54) Intelligent Full-Length Mirror

(71) Applicant: Shenzhen JeeTop Technology Limited, Shenzhen City (CN)

(72) Inventor: Lijun Hu, Shenzhen City, Guangdong Province (CN)

(21) Appl. No.: 19/014,728

(22) Filed: Jan. 9, 2025

(30) Foreign Application Priority Data
Mar. 8, 2024 (CN) 202420476620.1

(51) Int. Cl. F21V 33/00; F21V 29/50

(52) U.S. Cl. CPC F21V 33/004; F21V 29/50

(57) ABSTRACT

An intelligent full-length mirror is provided, relating to the technical field of mirrors. With the intelligent full-length mirror, mirror glass is fixed by means of a mirror frame. The mirror glass is provided with a shooting area and a display area. Another side of the mirror frame is provided with a shooting module and a master control module. The shooting module is directly opposite to the shooting area. The display area includes a display touch screen. The master control module is electrically connected to the display touch screen and the shooting module simultaneously, that is, the shooting module can be controlled to turn on and turn off by means of the display touch screen, the master control module can be started by means of the display touch screen too, and users can watch videos or perform other human-machine interaction operations by means of the display touch screen.

### CROSS REFERENCE TO RELATED APPLICATION

This patent application claims the benefit and priority of Chinese Patent Application No. 202420476620.1, filed with the China National Intellectual Property Administration on Mar. 8, 2024, the disclosure of which is incorporated by reference herein in its entirety as part of the present application.

### TECHNICAL FIELD

The present disclosure relates to the technical field of mirrors, more particularly to an intelligent full-length mirror.

### BACKGROUND

With the development of economy and the improvement of living standards, intelligent full-length mirrors can be seen everywhere in daily life, and the demand for human-machine interaction among users is increasing.

Existing intelligent mirrors generally have shooting modules fixedly and directly mounted on back sides of upper ends thereof, and users can take photos or videos by means of the shooting modules.

However, when the shooting module is located on the upper end of the mirror, if light supplementing is needed during shooting, it is needed to place a separate light supplementing lamp beside the mirror. When the mirror is moved, the light supplementing lamp needs to be moved too. Furthermore, it is also needed to adjust the light supplementing lamp to a proper position separately, in order to achieve a best light supplementing effect. All the above operations result in an inconvenience to photo or video shooting.

### SUMMARY

In view of the above, it is an object of the present disclosure to provide an intelligent full-length mirror so as to solve the technical problems in the existing technologies that intelligent mirrors need to be equipped with separate light supplementing lamps for light supplementing and thus cause inconveniences to operations.

In order to achieve the above object, the present disclosure provides an intelligent full-length mirror, including a supporting stand and a mirror component mounted on the supporting stand. An angle of supporting of the supporting stand is adjustable. The mirror component includes a mirror frame and mirror glass mounted on the mirror frame. The mirror glass is provided with a shooting area and a display area. Another side of the mirror frame opposite to the mirror glass is provided with a shooting module and a master control module. The shooting module is directly opposite to the shooting area. The display area includes a display touch screen. The master control module is electrically connected to the display touch screen and the shooting module simultaneously.

The intelligent full-length mirror further includes a light supplementing component arranged on the mirror frame.

Optionally, the light supplementing component includes a light supplementing lamp arranged on a top end of the mirror frame.

Optionally, between the light supplementing lamp and the mirror frame is provided a rotation limit piece configured to control an angle of rotation of the light supplementing lamp.

Optionally, the light supplementing component further includes an ambience lamp. The ambience lamp is arranged on the mirror frame and has light thereof transmitting through the mirror glass. The ambience lamp has a light-transmitting area located on a periphery of the shooting area and/or close to a periphery of an edge of the mirror glass.

Optionally, a back side of the mirror frame is further provided with a first accommodating box and a second accommodating box. The shooting module is arranged in the first accommodating box, and the master control module is arranged in the second accommodating box.

Optionally, between the first accommodating box and the second accommodating box is provided a wiring box configured for a wire connecting the shooting module and the master control module to pass through.

Optionally, an exhaust mechanism is further arranged in the second accommodating box, and the exhaust mechanism is located above the master control module.

Optionally, the exhaust mechanism is arranged as an RGB fan or a lightless or conventional computer cooling fan.

Optionally, the supporting stand includes a base and a first supporting rod, the first supporting rod is fixedly arranged on the mirror frame and has a bottom end rotatably connected to the base.

Optionally, the supporting stand further includes a second supporting rod, the base is formed with a plurality of engaging grooves in sequence, and the second supporting rod has one end rotatably connected to the first supporting rod and another end clamped into the engaging groove.

The intelligent full-length mirror provided by the present disclosure has the following technical effects.

The intelligent full-length mirror is mainly composed of a supporting stand and a mirror component, an angle of supporting of the supporting stand relative to the mirror component is adjustable, whereby being suitable for users of different heights. The mirror component includes a mirror frame and mirror glass, and the mirror glass is fixed by means of the mirror frame. The mirror glass is provided with a shooting area and a display area. Another side of the mirror frame opposite to the mirror glass is provided with a shooting module and a master control module. The shooting module is directly opposite to the shooting area. The display area includes a display touch screen. The master control module is electrically connected to the display touch screen and the shooting module simultaneously, that is, the shooting module can be controlled to turn on and turn off by means of the display touch screen, the master control module can be started by means of the display touch screen too, and users can watch videos or perform other human-machine interaction operations by means of the display touch screen.

The intelligent full-length mirror provided by the present disclosure further includes a light supplementing component mounted on the mirror frame, that is, the light supplementing component is directly connected to the mirror frame. When it is needed to supplement light during photo or video shooting, the master control module is controlled to turn on the light supplementing component to perform real-time light supplementing, which is simple and quick and overcomes the defects in the existing technologies that separate light supplementing lamps need to be frequently moved when employed for light supplementing.

### BRIEF DESCRIPTION OF THE DRAWINGS

For a better understanding of the technical solutions in the embodiments of the present disclosure or in the prior art, accompanying drawings required to be used in the description of the embodiments or the prior art are simply illustrated below. Apparently, the accompanying drawings described below are some embodiments of the present disclosure merely. For the ordinary skill in the field, other accompanying drawings may be obtained without creative effort according to these accompanying drawings, in which:

FIG. 1 is a perspective view of an intelligent full-length mirror of the present disclosure.

FIG. 2 is front view of the intelligent full-length mirror in FIG. 1.

FIG. 3 is rear view of the intelligent full-length mirror in FIG. 1.

FIG. 4 is side view of the intelligent full-length mirror in FIG. 1.

FIG. 5 is an internal structure diagram of a back side of the intelligent full-length mirror in FIG. 1.

FIG. 6 is an internal structure diagram of a front side of the intelligent full-length mirror in FIG. 1.

FIG. 7 illustrates the master control module's simultaneous connections with the display touch screen and the shooting module.

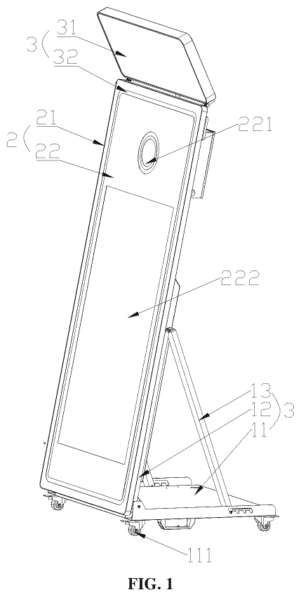

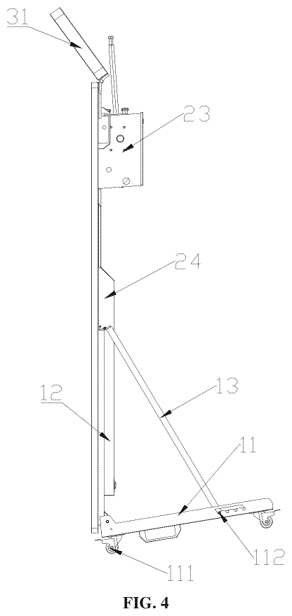

Herein, reference numerals in FIG. 1 to FIG. 7 are described as below.
1, supporting stand; 11, base; 111, universal wheel; 112, engaging groove; 12, first supporting rod; 13, second supporting rod;
2, mirror component; 21, mirror frame; 22, mirror glass; 221, shooting area; 222, display area; 23, first accommodating box; 24, second accommodating box; 25, wiring box;
3, light supplementing component; 31, light supplementing lamp; 32, ambience lamp; 4, shooting module; 41, shooting hole; and
5, master control module; 6, exhaust mechanism; and 7, display touch screen.

### DETAILED DESCRIPTION OF THE EMBODIMENTS

To make the purpose, the technical scheme and the advantages of the present disclosure more apparent and understandable, a detailed description is provided to the technical scheme in the embodiments of the present disclosure. Obviously, the embodiments described hereinafter are simply part embodiments of the present disclosure, rather than all of the embodiments. All other embodiments obtained by those skilled in the art based on the embodiments in the present disclosure without creative work are intended to be included in the scope of protection of the present disclosure.

Based on the defects of the intelligent full-length mirror in the conventional art, the intelligent full-length mirror provided by the present disclosure is described below in detail in conjunction with FIG. 1 to FIG. 7.

FIG. 1 to FIG. 7 shows structure diagrams of a preferred embodiment of an intelligent full-length mirror of the present disclosure. The intelligent full-length mirror includes a supporting stand 1 and a mirror component 2. The supporting stand 1 is configured to support the mirror component 2, and an angle of supporting of the supporting stand 1 relative to the mirror component 2 is adjustable, whereby being suitable for users of different heights.

In particular, the mirror component 2 includes a mirror frame 21 and mirror glass 22. The mirror glass 22 is used as a common mirror. The mirror frame 21 is used as a structure for mounting the mirror glass 22, whereby playing a function of supporting the mirror glass 22.

Herein, the mirror frame 21 and the mirror glass 22 are both in long-bar shapes preferably, with sizes close to the height of an adult, which can be used as a full-length floor mirror. It is to be noted that the mirror frame 21 and the mirror glass 22 can also be in other shapes, such as oval. Both shapes and sizes of the mirror frame 21 and the mirror glass 22 are not limited in the present disclosure.

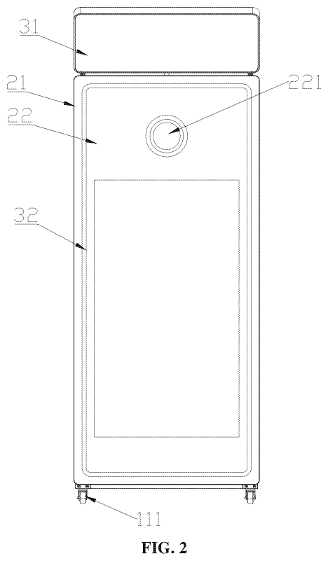

Since the present disclosure claims the protection of an intelligent full-length mirror, the mirror glass 22 of the present disclosure is provided with a shooting area 221 and a display area 222 at the same time. As shown in FIG. 2, the shooting area 221 is located above the display area 222. The shooting area 221 preferably is circular, and the display area 222 preferably is in a long-bar shape. In the present disclosure the shooting area 221 is a pure mirror surface with a one-way light-transmitting shooting hole 41 arranged in the center.

It should be noted that the shooting area 221 and the display area 222 can also be in other shapes. The shapes and sizes of the shooting area 221 and the display area 222 are not limited herein.

Corresponding to the shooting area 221 and the display area 222 on the mirror glass 22, the mirror frame 21 is provided with a shooting module 4 and a master control module 5. The shooting module 4 is located on a back side of the mirror frame 21, the shooting module 4 is corresponding to the shooting area 221, and the shooting module 4 completes a shooting function by means of the shooting area 221. The display area 222 includes a display touch screen 7. The display touch screen 7 is mounted on a back side of the mirror glass 22 and meanwhile is mounted on the mirror frame 21. The display touch screen 7 is corresponding to the master control module 5. The master control module 5 is electrically connected to the display touch screen 7 and the shooting module 4 simultaneously.

The master control module 5 in the present disclosure preferably is a microcomputer (including AMD, INTC, Loongson series, etc.), including a mainboard, a CPU (Central Processing Unit), a memory, a register, a communication interface, etc. The master control module 5 can be electrically connected to peripheral devices related to the intelligent mirror, for example, the shooting module 4, printing equipment, a loudspeaker, etc. The master control module 5 is configured to process or store tasks or data related to photo shooting and video play. The master control module 5 is connected to the communication interface, for example, a network card, a modem, a wireless communication transceiver, etc. A communication unit allows the master control module 5 to switch information/data with other devices, for example through a computer network of Internet and/or various telecommunication networks. The master control module 5 in the present embodiment can implement any function that can be implemented by a personal computer, for example, file browsing, user input, software program download, local area network connection, etc. In the present disclosure, the master control module 5 is provided with a wireless antenna and an RS454, RS232 or RJ45 wired interface, and is further installed with a Bluetooth related drive program.

The shooting module 4 in the present embodiment can be a Webcam, a camera, and also can be other elements capable of acquiring pictures, which are all intended to be covered in the scope of protection of the present disclosure.

It is to be noted that the master control module 5 in the present disclosure is not limited to a microcomputer, but also can be an embedded class of mainboards (chips based on ARM design, such as Allwinner chips, Mediatek chips, Rockchip chips, Hisilicon chips, Kirin chips, etc.). The system is based on WIN10, which is not limited to or employs operating systems such as Android, Harmony OS, Linux, KylinOS, etc., and which can also be WIN11 and other editions of WINDOWS systems.

The shooting module 4 in the present disclosure, for example, can be a binocular camera, a monocular camera, a rangefinder, a single lens reflex camera, a twin-lens reflex camera, a depth camera or a panorama camera, etc., which can be selected depending on actual conditions and is not limited in the present disclosure. The shooting module 4 and the master control module 5 are electrically connected. The master control module 5 is installed with software or program instructions configured to control the operations of the shooting module 4. The master control module 5 is called by means of the display touch screen 7, as shown in FIG. 7.

The intelligent full-length mirror provided by the present embodiment is capable of printing photos. When a user selects a camera function by means of the display touch screen 7, the shooting module 4 receives a command and then starts to shoot through the shooting hole 41 to obtain a photo, the photo is processed by the master control module 5 and then is transmitted to a printing device, and the printing device receives the real-time photo and prints it out autonomously.

In some examples, the printing device is a thermal printer, which has a low printing cost, a high printing speed and is quiet in printing, whereby being suitable for real-time printing of photos. The printing device can also be a thermal dye-sublimation printer.

In some embodiments, the master control module 5 sends out a continuous shooting command for continuous shooting, the shooting module 4 shoots N photos continuously through the shooting hole 41, where N can be any integer greater than 0. In some examples, the N is defined by a user. When the intelligent full-length mirror of the present embodiment is shooting, the shooting area 221 still presents out a mirror effect, which is not interfered by the shooting hole 41.

The display area 222 includes a display touch screen 7 having a mirror effect. A back side of the display area 222 is provided with a second accommodating box 24. The master control module 5 is placed inside the second accommodating box 24. The master control module 5 is electrically connected to the display touch screen 7. A user controls the master control module 5 by means of the display touch screen 7. When a user selects to play a video, the master control module 5 receives a command input by the user and then responds to the command and displays a corresponding interface and content on the display touch screen 7. When playing a video, the mirror effect of the display area 222 disappears, and the user can clearly watch the content being played. When the video play is ended, if the user inputs ending or if there is no user input for a long time, the display area 222 switches into the mirror effect.

In some embodiments, the display touch screen 7 can be an LCD (Liquid Crystal Display) screen, also can be an OLED (Organic Light-Emitting Diode) screen, or an LED (Light Emitting Diode) screen. Specifically, it can be selected depending on actual conditions, which is not limited in the present disclosure.

In order to supplement light in real time for the shooting module 4, as shown in FIG. 1 to FIG. 4, the intelligent full-length mirror further includes a light supplementing component 3 arranged on the mirror frame 21. The light supplementing component 3 is electrically connected to the master control module 5.

Specifically, the light supplementing component 3 in the present disclosure can be a light supplementing lamp 31. The light supplementing lamp 31 is arranged on a top end of the mirror frame 21, and has a same width as the mirror frame 21. The light supplementing lamp 31 is electrically connected to the master control module 5, and brightness of the light supplementing lamp 31 can be adjusted by means of an adjustment button.

Referring to FIG. 1, the light supplementing lamp 31 in the present disclosure can be rotated relative to the mirror frame 21, that is, the angle of the light supplementing lamp 31 relative to the mirror frame 21 can be changed. Between the light supplementing lamp 31 and the mirror frame 21 is provided a rotation limit piece configured to control an angle of rotation of the light supplementing lamp 31. Herein, the rotation limit piece is a hinge with a connection part, which is common in the conventional art, and no further description is needed here.

Besides the light supplementing lamp 31, in some embodiments, the light supplementing component 3 further includes an ambience lamp 32. The ambience lamp 32 preferably is an adjustable lamp tube. The ambience lamp 32 is arranged on the mirror frame 21 and has light thereof transmitting through the mirror glass 22, and the ambience lamp 32 has a light-transmitting area located on a periphery of the shooting area 221 and close to a periphery of an edge of the mirror glass 22.

A user controls the ambience lamp 32 and the light supplementing lamp 31 of the mirror by means of a special infrared remote control. The ambience lamp 32 can generate a lighting effect of monochromatic light or several colors of light arranged in certain sequence. Since different lighting effects irradiating on an object or people in front of the mirror can cause different shooting effects, moreover, the user in front of the mirror can learn the shooting effect of the current lighting effect according to the image reflected by the mirror, the lighting effect can be adjusted conveniently to what the user expects.

The mirror frame 21 in the present embodiment is further provided with a sound sensor. The sound sensor is configured to sense a music situation in the surroundings of the mirror. When there is no music being played in the surroundings of the mirror, a flashing state of the ambience lamp 32 is a state set by the remote control, and the current flashing state of the ambience lamp 32 is called a default state. When there is a music being played in the surroundings of the mirror, the sound sensor can detect the music and acquire a frequency, a tone and the like of the music, then the flashing condition of the ambience lamp 32 is adjusted correspondingly according to these information, for example, the flashing frequency, the color, the duration of each color and the like of the ambience lamp 32 are adjusted.

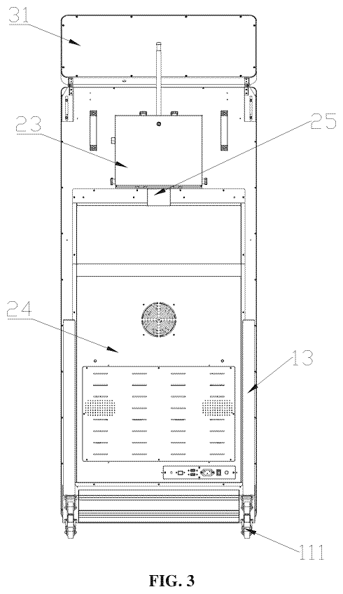

In addition, in order to protect the shooting module 4 and the master control module 5 in real time, a back side of the mirror frame 21 is further provided with a first accommodating box 23 and a second accommodating box 24, as shown in FIG. 3. The shooting module 4 is arranged in the first accommodating box 23, and the master control module 5 is arranged in the second accommodating box 24. The first accommodating box 23 is located above the second accommodating box 24, and the first accommodating box 23 has a smaller size but a greater thickness than the second accommodating box 24, whereby they are matched with the shooting module 4 and the master control module 5.

Meanwhile, referring to FIG. 3, between the first accommodating box 23 and the second accommodating box 24 is provided a wiring box 25. The wiring box 25 is intercommunicated with the first accommodating box 23 and the second accommodating box 24. The wiring box 25 is configured for a wire connecting the shooting module 4 and the master control module 5 to pass through. The wiring box 25 is convenient to arrange a wire between the shooting module 4 and the master control module 5.

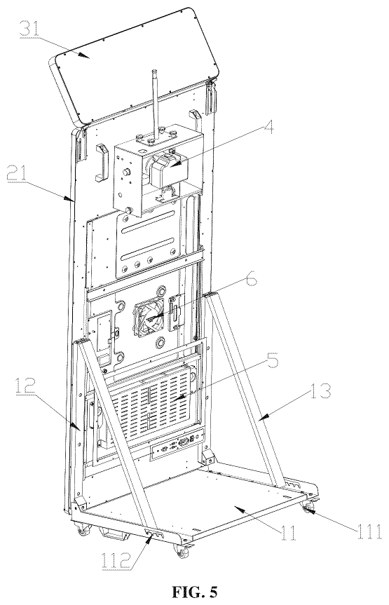

An exhaust mechanism 6 is further arranged in the second accommodating box 24, as shown in FIG. 3 and FIG. 5, the exhaust mechanism 6 preferably is an RGB fan, or a lightless or conventional computer cooling fan. The exhaust mechanism 6 is located above the master control module 5. The exhaust mechanism 6 is capable of exhausting out the heat of the internal electronic elements, so that the intelligent full-length mirror has a more stable internal heat balance.

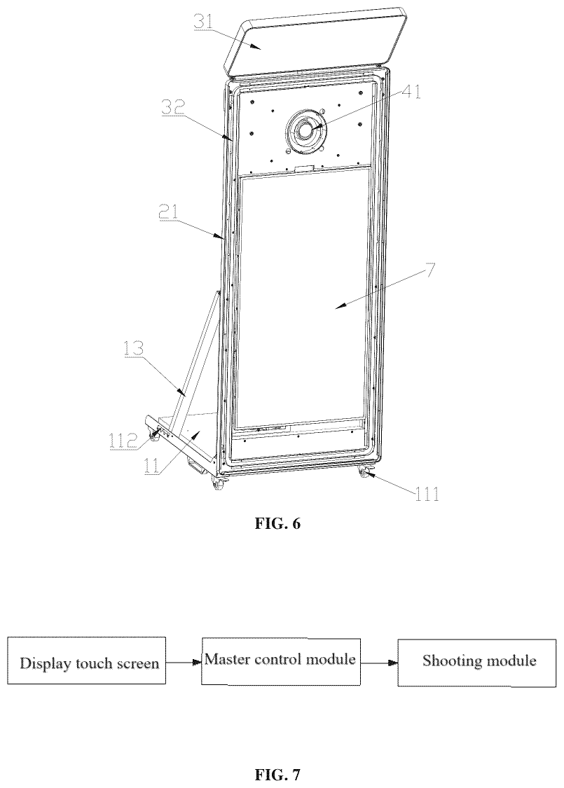

In more detail, as shown in FIG. 5 and FIG. 6, the supporting stand 1 includes a base 11, a first supporting rod 12 and a second supporting rod 13. The base 11 is provided with several universal wheels 111 therebelow. The universal wheels 111 are convenient for the intelligent full-length mirror to slide. The first supporting rod 12 is fixedly arranged on the mirror frame 21 and has a bottom end rotatably connected to the base 11. The base 11 is formed with a plurality of engaging grooves 112 in sequence. The present embodiment preferably has four engaging grooves 112. The second supporting rod 13 has one end rotatably connected to the first supporting rod 12 and another end clamped into the engaging groove 112.

When it is needed to change the angle between the mirror component 2 and the supporting stand 1, the second supporting rod 13 is pulled out from the engaging groove 112 and inserted into another engaging groove 112, meanwhile the angle of the first supporting rod 12 relative to the base 11 is adjusted synchronously, the angle between the first supporting rod 12 and the second supporting rod 13 is adjusted synchronously, whereby the mirror component 2 reaches a most suitable angular position.

In the description of the present disclosure, unless otherwise stated, “a plurality of” means two or more than two; the orientation or position relations indicated by such terms as “upper”, “lower”, “left”, “right”, “inner”, “outer”, “front end”, “rear end”, “head” and “tail” used in the description are based on the orientation or position relations shown in the drawings, and are merely for conveniently describing the present disclosure and simplifying the description, rather than indicating or implying that the device or element must have the specific orientation and be constructed and operated according to the specific orientation. Therefore, they should not be construed as a limitation on the present disclosure. In addition, terms such as “first”, “second”, “third”, etc. are used merely for the purpose of description, and should not be construed as indicating or implying the degrees of importance.

In the description of the present disclosure, unless otherwise specifically stated and defined, terms such as “mounting”, “interconnection”, “connection”, etc. should be interpreted expansively. For example, they may be fixed connection, also may be detachable connection, or integration; may be mechanical connection, also may be electrical connection; may be direct connection, also may be indirect connection through an intermediate. The ordinary skill in this field can understand the specific implication of the above terms in the present disclosure in accordance with specific conditions.

The above are merely particular embodiments of the present disclosure, and the protection scope of the present disclosure is not limited thereto. All of the variations or substitutions that a person skilled in the art may easily envisage within the technical scope disclosed by the present disclosure should fall within the protection scope of the present disclosure. Therefore, the protection scope of the present disclosure should be subject to the protection scope of the claims appended herein.

What is claimed is:

1. An intelligent full-length mirror, comprising a supporting stand and a mirror component mounted on the supporting stand, wherein an angle of supporting of the supporting stand is adjustable, the mirror component comprises a mirror frame and mirror glass mounted on the mirror frame, the mirror glass is provided with a shooting area and a display area, another side of the mirror frame opposite to the mirror glass is provided with a shooting module and a master control module, the shooting module is directly opposite to the shooting area, the display area comprises a display touch screen, and the master control module is electrically connected to the display touch screen and the shooting module simultaneously; and
the intelligent full-length mirror further comprising a light supplementing component arranged on the mirror frame.

2. The intelligent full-length mirror according to claim 1, wherein the light supplementing component comprises a light supplementing lamp arranged on a top end of the mirror frame.

3. The intelligent full-length mirror according to claim 2, wherein between the light supplementing lamp and the mirror frame is provided a rotation limit piece configured to control an angle of rotation of the light supplementing lamp.

4. The intelligent full-length mirror according to claim 2, wherein the light supplementing component further comprises an ambience lamp, the ambience lamp is arranged on the mirror frame and has light thereof transmitting through the mirror glass, and the ambience lamp has a light-transmitting area located on a periphery of the shooting area and/or close to a periphery of an edge of the mirror glass.

5. The intelligent full-length mirror according to claim 2, wherein a back side of the mirror frame is further provided with a first accommodating box and a second accommodating box, the shooting module is arranged in the first accommodating box, and the master control module is arranged in the second accommodating box.

6. The intelligent full-length mirror according to claim 5, wherein between the first accommodating box and the second accommodating box is provided a wiring box configured for a wire connecting the shooting module and the master control module to pass through.

7. The intelligent full-length mirror according to claim 5, wherein an exhaust mechanism is further arranged in the second accommodating box, and the exhaust mechanism is located above the master control module.

8. The intelligent full-length mirror according to claim 7, wherein the exhaust mechanism is arranged as an RGB fan or a lightless or conventional computer cooling fan.

9. The intelligent full-length mirror according to claim 5, wherein the supporting stand comprises a base and a first supporting rod, the first supporting rod is fixedly arranged on the mirror frame and has a bottom end rotatably connected to the base.

10. The intelligent full-length mirror according to claim 9, wherein the supporting stand further comprises a second supporting rod, the base is formed with a plurality of engaging grooves in sequence, and the second supporting rod has one end rotatably connected to the first supporting rod and another end clamped into the engaging groove.
